(19) United States
(12) Patent Application Publication
(10) Pub. No.: US 2011/0159241 A1
(43) Pub. Date: Jun. 30, 2011

(54) ADHESIVE TAPE WITH ADHESION ENHANCEMENT AND DIRECTIONALITY BY MATERIAL, STRUCTURAL, AND ADHESIVE HETEROGENEITY

(75) Inventors: Shuman Xia, Pasadena, CA (US); Laurent Ponson, Sartrouville (FR); Guruswami Ravichandran, Arcadia, CA (US); Kaushik Bhattacharya, La Canada Flintridge, CA (US)

(73) Assignee: California Institute of Technology, Pasadena, CA (US)

(21) Appl. No.: 12/978,504

(22) Filed: Dec. 24, 2010

Related U.S. Application Data
(60) Provisional application No. 61/290,133, filed on Dec. 24, 2009.
(60) Provisional application No. 61/376,183, filed on Aug. 23, 2010.

(51) Int. Cl. B32B 7/02; B32B 3/30; B32B 3/10; B29C 39/00

(52) U.S. Cl. 428/156; 428/212; 428/195.1; 264/299

(57) ABSTRACT

An adhesive system with material and structural heterogeneity is described. The adhesive system comprises a tape having a spatially heterogeneous physical property, the spatially heterogeneous physical property is configured to enhance the adhesive strength of the adhesive system when the adhesive system is in contact with a substrate and/or attain adhesion directionality. The spatially heterogeneous physical property can include a bending stiffness. Heterogeneous variations in the bending stiffness can be achieved by variations in the tape's thickness, elastic modulus and/or Poisson's ratio. Heterogeneity in thickness can be attained by mold pressing and/or patterned laminated structures. Elastic modulus heterogeneity can be achieved by masked irradiation of the tape, where the tape is made of an irradiation-sensitive material. Also described is an adhesive system with a patterned film that exhibits adhesion directionality when the adhesive system is in contact with a substrate.

### CROSS-REFERENCE TO RELATED APPLICATIONS

This application claims priority to and the benefit of co-pending U.S. provisional patent application Ser. No. 61/290,133, filed Dec. 24, 2009, and priority to and the benefit of co-pending U.S. provisional patent application Ser. No. 61/376,183, filed Aug. 23, 2010, each of which applications is hereby incorporated by reference herein in its entirety.

### STATEMENT REGARDING FEDERALLY FUNDED RESEARCH OR DEVELOPMENT

The U.S. Government has certain rights in this invention pursuant to Grant No. DMR-0520565 awarded by the National Science Foundation.

### THE NAMES OF THE PARTIES TO A JOINT RESEARCH AGREEMENT

NOT APPLICABLE.

### BACKGROUND OF THE INVENTION

1. Field of the Invention

The invention relates to adhesive tape in general and particularly to a system and method for adhesion enhancement and directionality by material, structural, and adhesive heterogeneity.

2. Description of Related Art

Adhesive tapes have been used for various purposes, ranging from simple home and office use to high performance industrial applications. The world market of pressure sensitive adhesive (PSA) tapes, one of many varieties of adhesive tapes, is expected to reach $26 billion by 2012 according to a market research report by the Freedonia Group.

An adhesive tape is typically made of a homogeneous backing material uniformly coated with an adhesive layer. The bonding strength of the tape is characterized by the peel force required to peel the tape off a substrate. The peel force is mainly determined by the peel angle and the adhesion property of the adhesive layer. In the past, improvement in tape bonding performance has typically been achieved by means of chemical design of the adhesive layer with stronger adhesion strength.

Some work in the prior art has focused on increasing adhesion strength in a tape by generating patterns in the adhesive layer. For example, Daniel A. Ramrus and John C. Berg in their article Enhancement of Adhesion to Heterogeneously Patterned Substrates (Colloids and Surfaces A: Physicochem. Eng. Aspects, 273 84-89 (2006)) describe an enhancement effect that is related to the heterogeneous distribution of the adhesive layer. In particular their work explores the role of heterogeneity in a silane film that has adhesion-promoting and non-adhesion promoting regions. In a related work, the same authors study the effect of water penetration on adhesion properties (D. A. Ramrus and J. C. Berg, Using Heterogeneous Silane Patterns to Maintain Adhesion and Decrease Water Penetration into Epoxy/Aluminum Interfaces, J. Adhesion Sci. Technol., 20:1615-1623 (2006)). U.S. Pat. No. 6,309,745 also describes a system with a patterned adhesive layer. The focus of the patent is on the reversible adhesion properties of the adhesive tape.

### SUMMARY OF THE INVENTION

In one aspect, the invention relates to an adhesive system that can be applied to a substrate. The adhesive system comprises a backing layer having a spatially heterogeneous physical property and an adhesive layer situated on the backing layer, the spatially heterogeneous physical property is configured to enhance an adhesive strength of the adhesive system when the adhesive system is in contact with the substrate.

In one embodiment, the spatially heterogeneous physical property includes a bending stiffness. In one embodiment the backing layer has variations in at least one of a thickness thereof, an elastic modulus thereof, and Poisson's ratio thereof. In one embodiment, the heterogeneity in the bending stiffness is achieved by heterogeneity in at least one of a thickness and an elastic modulus. In one embodiment, the heterogeneity in the thickness is achieved by at least one of mold pressing and patterned laminated structures. In one embodiment, the heterogeneity in the elastic modulus is achieved by masked irradiation of the backing layer, the backing layer being made of an irradiation-sensitive material. In one embodiment, the spatially heterogeneous physical property is spatially heterogeneous in a pattern. In one embodiment the spatially heterogeneous physical property that is spatially heterogeneous in a pattern comprises a first array of striped regions having a first value of the spatially heterogeneous physical property interspersed with a second array of striped regions having a second value of the spatially heterogeneous physical property. In one embodiment, the spatially heterogeneous physical property that is spatially heterogeneous in a pattern comprises a first array of square regions having a first value of the spatially heterogeneous physical property, each of the square regions of the array surrounded by a second region having a second value of the spatially heterogeneous physical property.

In another aspect, the invention relates to a method of fabricating an adhesive system. The method comprises providing a backing layer having a spatially heterogeneous physical property and situating an adhesive layer on the backing layer. The spatially heterogeneous physical property is configured to enhance an adhesive strength of the adhesive system when the adhesive system is applied to a substrate.

In one embodiment, the spatially heterogeneous physical property includes a bending stiffness. In one embodiment the heterogeneity in the bending stiffness is achieved by heterogeneity in at least one of a thickness and an elastic modulus. In one embodiment, the spatially heterogeneous physical property is spatially heterogeneous in a pattern. In one embodiment, the spatially heterogeneous physical property that is spatially heterogeneous in a pattern comprises a first array of striped regions having a first value of the spatially heterogeneous physical property interspersed with a second array of striped regions having a second value of the spatially heterogeneous physical property. In one embodiment, the spatially heterogeneous physical property that is spatially heterogeneous in a pattern comprises a first array of square regions having a first value of the spatially heterogeneous physical property, each of the square regions of the array surrounded by a second region having a second value of the spatially heterogeneous physical property.

In another aspect, the invention relates to an adhesive system that can be applied to a substrate. The system comprises a backing layer and an adhesive layer situated on the backing layer, the adhesive layer having a pattern. The pattern is configured such that removing the adhesive system from the substrate along a first direction has a first peel force value and removing the adhesive system from the substrate along a second direction has a second peel force value, the first peel force value being different from the second peel force value.

In another aspect, the invention relates to an adhesive system that can be applied to a substrate. The adhesive system comprises a backing layer and an adhesive layer situated on the backing layer, the adhesive layer having a pattern. The pattern is configured to attain adhesion directionality when the adhesive system is in contact with the substrate. In one embodiment, the pattern comprises a spatially heterogeneous distribution of adhesion energy. In another embodiment the pattern comprises an array of elements having a first value of the spatially heterogeneous adhesion energy, the array of elements interspersed with regions having a second value of the spatially heterogeneous adhesion energy. In one embodiment, the array of elements comprises an array of curved elements having a convex profile along a first direction and a concave profile along a second direction.

In a further aspect, the invention relates to an adhesive system that can be applied to a substrate. The system comprises a first region of a heterogeneous film having a first value of an elastic property and a second region of the heterogeneous film having a second value of the elastic property. The first region and the second region are configured to cooperate to enhance an adhesive strength of the adhesive system when the adhesive system is in contact with the substrate. In one embodiment, the elastic property is at least one of a thickness, an elastic modulus, and a Poisson's ratio. In one embodiment, the elastic property includes a bending stiffness. In one embodiment, the first value and the second value of the bending stiffness are achieved by heterogeneity in at least one of a thickness and an elastic modulus. In one embodiment, the heterogeneity in the thickness is achieved by at least one of mold pressing and patterned laminated structures. In one embodiment, the heterogeneity in the elastic modulus is achieved by masked irradiation of the heterogeneous film, the heterogeneous film being made of an irradiation-sensitive material. In one embodiment, the system further comprises an adhesive layer, the adhesive layer being disposed between the heterogeneous film and the substrate when the adhesive system is in contact with the substrate. In one embodiment, the first region and the second region form a pattern, at least one of the first region and the second region comprising a plurality of elements. In one embodiment, the pattern comprises at least one of a striped pattern and an array of squares.

In still another aspect, the invention relates to a method of fabricating an adhesive system that can be applied to a substrate. The method comprises generating a first region of a heterogeneous film having a first value of an elastic property; and generating a second region of the heterogeneous film having a second value of the elastic property. The first region and the second region are configured to cooperate to enhance an adhesive strength of the adhesive system when the adhesive system is in contact with the substrate. In one embodiment, the elastic property includes a bending stiffness. In one embodiment, the elastic property is spatially heterogeneous in a pattern. In one embodiment, the elastic property that is spatially heterogeneous in a pattern comprises at least one of: a first array of striped regions having a first value of the elastic property interspersed with a second array of striped regions having a second value of the elastic property, and a first array of square regions having a first value of the elastic property, each of the square regions of the array surrounded by a second region having a second value of the elastic property.

In yet another aspect, the invention relates to an adhesive system that can be applied to a substrate. The system comprising a first region of a heterogeneous film having a first value of an elastic property; and a second region of the heterogeneous film having a second value of the elastic property. The first region and the second region are configured to cooperate to provide directional anisotropy in removing the adhesive system from the substrate. In one embodiment, configured to cooperate to provide directional anisotropy in removing the adhesive system from the substrate includes exhibiting a first peel force value along a first direction and exhibiting a second peel force value along a second direction, the first peel force value being different from the second peel force value and the second direction being opposite to the first direction. In one embodiment, the first region and the second region are configured to cooperate to enhance an adhesive strength of the adhesive system when the adhesive system is in contact with the substrate. In one embodiment, the system further comprises an adhesive layer, the adhesive layer being disposed between the heterogeneous film and the substrate when the adhesive system is in contact with the substrate.

In yet a further aspect, the invention relates to an adhesive system that can be applied to a substrate. The system comprises a first region of a heterogeneous film having a first value of an adhesive property; and a second region of the heterogeneous film having a second value of the adhesive property. The first region and the second region are configured to cooperate to provide directional anisotropy in removing the adhesive system from the substrate. In one embodiment, configured to cooperate to provide directional anisotropy in removing the adhesive system from the substrate includes exhibiting a first peel force value along a first direction and exhibiting a second peel force value along a second direction, the first peel force value being different from the second peel force value and the second direction being opposite to the first direction. In one embodiment, the first region comprises a plurality of curvilinear elements having a convex profile along a first direction and a concave profile along a second direction. In one embodiment, the system further comprises an adhesive layer, the adhesive layer being disposed between the heterogeneous film and the substrate when the adhesive system is in contact with the substrate.

In a further aspect, the invention relates to an adhesive system that can be applied to a substrate. The system comprises a first region of a heterogeneous film having a first value of at least one of an elastic property and an adhesive property; and a second region of the heterogeneous film having a second value of at least one of the elastic property and the adhesive property; the first value and the second value of the elastic property configured to cooperate to achieve at least one of: providing an enhanced adhesive strength of the adhesive system when the adhesive system is in contact with the substrate, and providing directional anisotropy in removing the adhesive system from the substrate, and the first value and the second value of the adhesive property configured to cooperate to provide directional anisotropy in removing the adhesive system from the substrate.

In one embodiment, configured to cooperate to provide directional anisotropy in removing the adhesive system from the substrate includes exhibiting a first peel force value along a first direction and exhibiting a second peel force value along a second direction, the first peel force value being different from the second peel force value and the second direction being opposite to the first direction. In one embodiment, the elastic property is at least one of a thickness, an elastic modulus, and a Poisson's ratio. In one embodiment, the elastic property includes a bending stiffness. In one embodiment, the first value and the second value of the bending stiffness are achieved by heterogeneity in at least one of a thickness and an elastic modulus. In one embodiment, heterogeneity in the thickness is achieved by at least one of mold pressing and patterned lamination. In one embodiment heterogeneity in the elastic modulus is achieved by masked irradiation of the heterogeneous film. In one embodiment, the system further comprises an adhesive layer, the adhesive layer being disposed between said heterogeneous film and the substrate when the adhesive system is in contact with the substrate. In one embodiment, the first region and the second region form a pattern, at least one of the first region and the second region comprising a plurality of elements. In one embodiment, the pattern comprises at least one of a striped pattern, and an array of squares. In one embodiment, the first region comprises a plurality of curvilinear elements having a convex profile along the first direction and a concave profile along the second direction.

In yet another aspect, the invention relates to a method for fabricating an adhesive system that can be applied to a substrate. The method comprises generating a first region of a heterogeneous film having a first value of at least one of an elastic property and an adhesive property; and generating a second region of the heterogeneous film having a second value of at least one of the elastic property and the adhesive property; the first value and the second value of the elastic property configured to cooperate to achieve at least one of: providing an enhanced adhesive strength of the adhesive system when the adhesive system is in contact with the substrate, and providing directional anisotropy in removing the adhesive system from the substrate, and the first value and the second value of the adhesive property configured to cooperate to provide directional anisotropy in removing the adhesive system from the substrate.

In one embodiment, the elastic property is at least one of a thickness, an elastic modulus, and a Poisson's ratio. In another embodiment the first region and the second region form a pattern, at least one of the first region and the second region comprising a plurality of elements. In one embodiment the first region comprises a plurality of curvilinear elements having a convex profile along a first direction and a concave profile along a second direction, the second direction being opposite to said first direction.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a drawing of a heterogeneous tape with a striped pattern;

FIG. 1B is a drawing of a heterogeneous tape with a square pattern;

FIG. 2 shows a computer-simulated curve of the peel force versus displacement for two types of heterogeneous tape and homogeneous tape reference value;

FIG. 3 shows the curves of the adhesion enhancement ratio versus the elasticity mismatch ratio for two types of heterogeneous tape;

FIG. 4 is a plot showing the difference in peel force between homogeneous and heterogeneous tape;

FIG. 5 is a plot showing the enhancement ratio as a function of peel angle for heterogeneous tape;

FIG. 6 is a top down image showing peel front pinning of a heterogeneous adhesive interface; and

FIG. 7A is a drawing of the peeling of a polydimethylsiloxane (PDMS) sheet from a transparency film printed with moon or crescent like ink patterns;

FIG. 7B is the geometric definition of the periodic ink microstructure shown in FIG. 7A; and

FIG. 8 is a plot showing peel force vs. displacement for an oppositely oriented array of the patterns shown in FIG. 7B.

### DETAILED DESCRIPTION OF THE INVENTION

Adhesive tape is ubiquitous in daily life with numerous physical and biological systems providing examples of the peeling of a thin membrane from a relatively stiff surface or substrate. According to one description, the stickiness of such membranes is determined by a complex process involving the interplay of at least three factors: the inherent properties of the adhesive and backing layers, the geometry of the adhesive and backing layers and the deformation processes that accompany the peeling.

The object of the present invention is to provide a method for mechanically enhancing the effective bonding performance and/or attaining adhesion directionality of adhesive tapes by introducing heterogeneity in their material and structural properties. According to one embodiment of the invention, heterogeneity in the physical properties of the tape is employed to increase stickiness. In one particular embodiment, variations in the elastic properties of the tape constitute the heterogeneous physical property. In another particular embodiment, variations in the bending stiffness of the tape constitute the heterogeneous physical property. According to the invention, a variety of methods can be used to create the desired heterogeneity in tape bending stiffness. These include, but are not limited to, creating a spatially nonuniform distribution of tape thickness, for example by mold pressing, fabricating patterned laminated structures, elastic modulus patterning, for example by masked irradiation if the tape backing material is irradiation-sensitive, and varying the Poisson ratio.

According to one embodiment of the invention, heterogeneity in adhesion energy of the adhesive layer is employed to attain adhesion directionality. Various combinations of these methods are also contemplated in accordance with the principles of the invention. Variations in the adhesive and elastic properties of the tape can occur along an abrupt discontinuous interface, in a smooth continuous manner, or via a combination of the two. In various embodiments the elastic and adhesive properties of the tape are combined in a single film or layer and in other embodiments the elastic and adhesive properties are separated in two or more distinct layers. As a single layer or film, the tape has a generally planar profile without significant three dimensional topology. According to the principles of the invention for one embodiment, computer simulations were used to demonstrate the adhesion enhancement associated with striped and square patterned heterogeneity in tape bending stiffness.

An advantage of the present invention is its ability to be implemented in and integrated with existing commercial adhesion tapes at a low cost. In addition the mechanical adhesion enhancement is large, and additional to whatever is attainable by the chemical design of adhesive layers.

The invention is not limited to a specific pattern or heterogeneous arrangement such as the stripe, square and moon- or crescent-like patterns discussed below. According to the principles of the invention, other geometries, such as discs, triangles, hexagons, waves, and curves and curvilinear objects in a regular or irregular arrangement can be employed as heterogeneous patterns for adhesion enhancement and directionality. In addition heterogeneous patterns according to the invention may appear random without any regular structure. In a particular embodiment, the specific pattern size and spacing is optimized for the specific structural and material properties of the particular embodiment to reach the best adhesion performance and/or adhesion directionality.

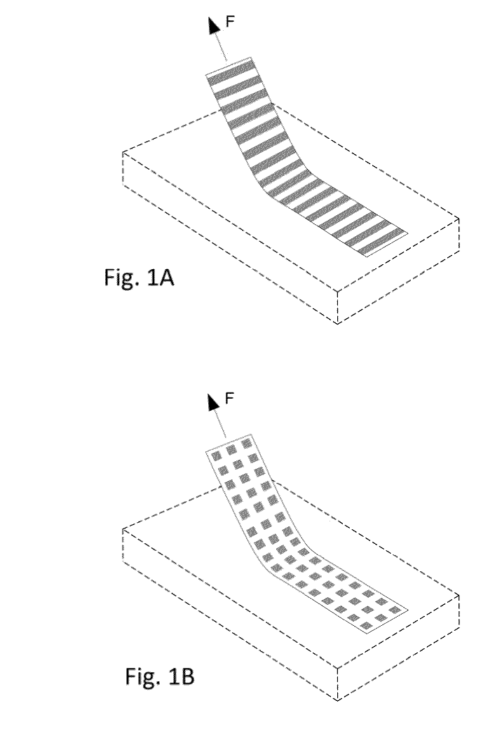

Referring now to the invention in more detail, in FIGS. 1A and 1B there are shown pictorial representations of two types of heterogeneous adhesive tapes whose adhesion are enhanced by stripe and square patterns. The base backing material is colored in white. The areas shaded in gray are the modified regions with different bending stiffness than the base. The modified regions can be either modified regions of the original base backing layer or an additional layer with different structural properties. The substrate to which the tape is either removably or permanently affixed is illustrated in dotted lines and is not claimed as part of the invention.

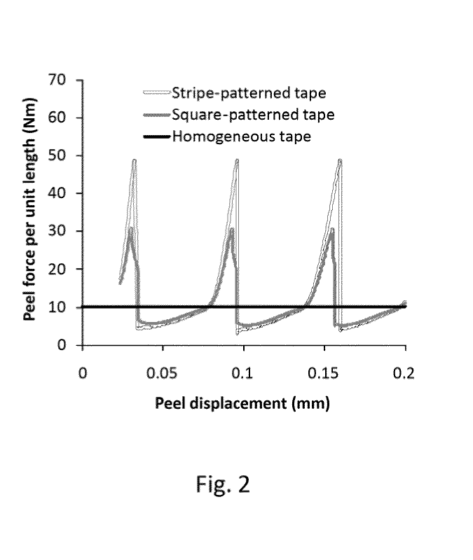

Reference is now made to FIG. 2, which shows the computer-simulated peel force-displacement curves of the stripe- and square-patterned tapes at a peel angle of 45 degrees. A commercial finite element analysis (FEA) package, ABAQUS, together with a user-defined subroutine code, has been employed to obtain these curves. The material properties used for the simulations are: for the unmodified backing material—adhesion energy G₁=3 J/m², Young's modulus E₁=50 MPa (also known as elastic modulus), and Poisson's ratio v₁=0.3; for the modified areas—adhesion energy G₂=3 J/m², Young's modulus E₂=1000 MPa, Poisson's ratio v₂=0.3. The geometric parameters are: for the stripe-patterned tape—tape thickness t₁=20 μm, stripe width w₁=100 μm, and stripe spacing d₁=100 μm; for the square-patterned tape—tape thickness t₂=20 μm, square size w₂=100 μm, and square spacing d₂=100 μm.

FIG. 2 shows that the peel force of the heterogeneous tapes varies significantly as the peel displacement increases. The peel force-displacement curve of a homogeneous tape (E₁=E₂=50 MPa) is also plotted as a reference for comparison, and is represented as a constant value vs. displacement. The peel force of the heterogeneous tapes increases rapidly as the peel front propagates from a low-bending-stiffness region into a high-bending-stiffness region, reaches a maximum and drops to a level below the reference line. To peel off the heterogeneous tapes from the substrate, the applied peel force has to overcome the peak values of the peel force-displacement curves. Therefore, the bonding performance of the tapes is determined by these peak values. FIG. 2 shows that the critical peel-off force of the stripe-patterned and square-patterned tapes is increased by about 380% and 200%, respectively, compared to the homogeneous tape.

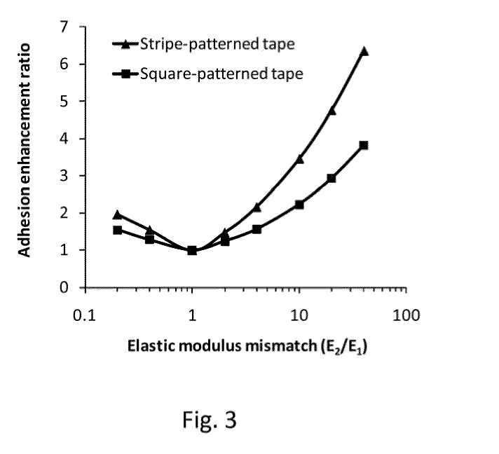

A parametric study has been carried out to determine the range of adhesion enhancement due to bending stiffness heterogeneity. The modulus of the patterned areas, E₂, was varied while keeping other parameters unchanged. FIG. 3 shows the curves of adhesion enhancement ratio vs. elastic modulus mismatch (E₂/E₁). The adhesion enhancement ratio is defined as the critical peel-off force normalized by that of the homogeneous tape. When E₂ becomes substantially smaller or greater than E₁, the enhancement effect is obvious for both heterogeneous tapes. A pronounced increase of 535% and 281% in bonding performance is observed, respectively, for the stripe- and square-patterned tapes with an elastic modulus mismatch of 40:1. The adhesion enhancement effect of the stripe-patterned tape is at maximum when the peel direction is perpendicular to the stripe direction, and is zero along the stripe direction. On the other hand, the square-patterned tape exhibits enhancement in all directions.

According to one embodiment of the invention, patterning the elastic modulus of an adhesive tape can significantly enhance its stickiness. This can in turn induce directionality such that the stickiness when peeling from one end to another is different from that when peeling the other way. According to one embodiment of the invention, this enhancement in stickiness comes from perturbations introduced into the relatively small energy associated with the bending of the tape near the front that separates the bonded from the unbonded region. This is an illustration of the principle that in complex processes perturbations with seemingly small energies can have anomalously large macroscopic effects.

Consider the process of peeling a thin homogeneous adhesive tape from a rigid substrate. As is known in the prior art, an initial description of the process can be obtained from the Rivlin-Kendall model. As the tape is peeled, the incremental work done by the peeling force advances the peeling front and stretches the increment of tape that has just been freed. This simple balance gives a relation that can be used to characterize the force Fₚ required to peel the tape in terms of the energy required to break the glue (the critical energy release rate G_{c}),

$${F}_{p} ( 1 - cos θ ) = {G}_{c} b - \frac{{F}_{p}^{2}}{2 Ebh}$$

where E is the elastic modulus, θ is the peel angle, b is the table width, and h is the tape thickness.

It is important to note that in the theoretical description given above, the energy associated with the sharp bend near the front that separates the region where it is bonded to the substrate from the region where it is free is not considered. In thin tape, this energy is relatively small as compared to the energy associated with the stretch of the tape, the adhesive energy of failure, and the like, as will be familiar to one skilled in the art. Moreover, if the system is homogeneous, this relatively small energy remains essentially unchanged as the tape is peeled.

According to the principles of the present invention, however, making the relatively small bending energy heterogeneous can have a significant effect on the force required to peel the tape. According to the principles of the invention, this heterogeneity can be achieved by various means including but not limited to patterning the elastic modulus of the tape or patterning the glue. According to one theoretical description of the invention, an important factor relevant to the peeling process is the rate of change of the energy and not the energy itself According to this description, a non-negligible energy release rate can be associated with an overall negligible energy.

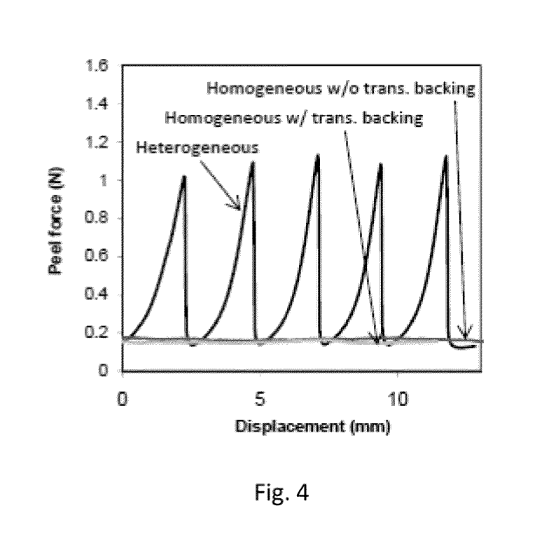

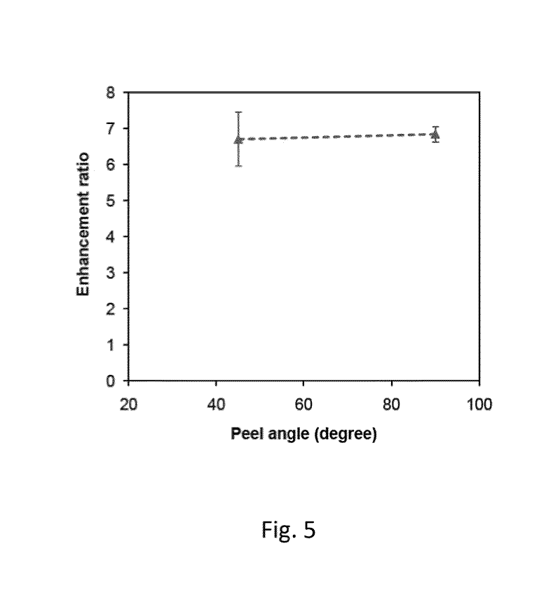

As a demonstration of this concept, a tape with alternating elastic stiffness was fabricated by gluing stripes of a thick polyester film on the back-side of another polyester film. A thin polydimethylsiloxane (PDMS) film is spin-coated and cured on the other side of the polyester film to work as an adhesive layer. The result was a heterogeneous tape with alternating stiff and compliant stripes as shown schematically in FIG. 1A. The heterogeneous tape was peeled from a glass substrate by imposing a constant velocity at a constant angle. As shown in FIG. 4, the measured peeling force oscillates as the peeling front traverses the stiff and compliant portions of the tape. It was verified that this curve is relatively insensitive to the peeling rate within a certain range. The effective force required to peel a macroscopic length of this tape is equal to the peak of the measured force above since the peeling front would get stuck if the applied force was smaller than the peak force. The effective peeling force of 1.08 N is considerably larger than the measured force of 0.16 N required to peel either a homogeneous compliant tape (without the stiffer transparency material attached to it) or a homogenous stiff tape (with a stiff transparency layer uniformly attached to it). These enhancement ratios as a function of peel angle are shown in FIG. 5.

The enhancement in tape stickiness by several factors due to the patterning of the elastic stiffness cannot be explained by the traditional Rivlin-Kendal model or by a typical analysis of the chemical properties of the glue. According to the principles of the invention, the theoretical analysis considers the role that bending plays by treating the tape as inextensible Euler-Bernoulli beam. At any instant, the angle θ that the tangent to the tape makes to a rigid surface is governed by the equation

$$EI {θ}^{″} ( s ) P {\int }_{0}^{s} cos θ ( ξ ) d ξ = 0$$

where EI is the bending rigidity, s is the arc-length of the tape from the peeling front, the prime denotes derivative with respect to arc-length and P is the applied or peeling force. The analysis considers a tape with a single interface at s* that separates a compliant region distal from the peel front from a stiff region proximal to the peel front. At this interface, constraints are imposed:
[[θ]]=0, tangent continuity and
[[EIθ′]]=0, moment continuity.

Finally, the boundary conditions are imposed: θ(0)=0 and θ→θ₀ (the applied peal angle as s→∞). The solution to these equations provides the shape of the released tape. This is used to compute the bending energy stored in the tape. Now the previous idea is invoked: the incremental work done by the peeling force is equal to the sum of the incremental change in the bending energy stored in the tape and the incremental work of advancing the peel front. From this can be computed the peeling force for heterogeneous tape as the distance between the peel front and the interface changes. The effective or peak force as the peel front crosses over from the compliant to the stiff region is obtained in agreement with the experimental observations. Further, it was shown that the ratio of the effective force of a heterogeneous tape to that of a homogenous tape is equal to the ratio of the bending rigidity:

$$Adhesive enhancement ratio = \frac{{( EI )}^{stiff}}{{( EI )}^{compliant}}$$

For the tapes used in the experiment, the ratio of the bending rigidity is 8. This agrees with the experimentally observed ratio of 6.8. Further, this ratio is independent of the peeling angle, and this is again confirmed by experimental observations as shown in FIG. 5. Finally, as the bending rigidity depends on the third power of the thickness, the adhesive enhancement ratio equation above shows that modulating the thickness of the tape can have a significant effect on the adhesion.

The mechanism of the enhancement is clear from both the experiment and the model: as the peeling front traverses from the compliant to the stiff material, a significant portion of the work done by the peeling force goes into bending the suddenly stiffer region. This drains energy away from the peeling front. This is what gives rise to a peak in the peeling force. The complementary dip occurs as the front traverses from the stiff to the compliant region. Once again, the bending energy is small, but its rate of change is large enough to generate significant effects.

According to the invention, it is expected that additional embodiments exist in which the adhesive properties of the adhesive layer and the heterogeneous mechanical elastic properties of the backing layer can be combined in a single layer or film that achieves enhanced adhesion according to the principles described herein. In one such particular embodiment, an elastically heterogeneous film is made to adhere to a smooth surface using natural Van der Waals forces. Within the scope of the invention, the adhesion of the film to a substrate is not limited to a specific mechanism and can include, for example, adhesion due to electrostatic attraction, Van der Waals forces, capillarity forces and/or chemical affinity.

An exploration of the adhesion directionality was also conducted. The adhesion energy of a homogeneous interface is isotropic, i.e., the resistance to fracture is the same for all fracture directions. However, for many engineering applications, anisotropic adhesion properties are highly desired. For example, future wall-climbing robots without complex suction mechanisms can be developed by designing adhesive patches with strong resistance to peeling in one direction, and weak resistance in the opposite direction. According to the principles of one embodiment of the present invention, a methodology to achieve direction-dependent peeling resistance is presented. It has been recognized that one can introduce anisotropy with respect to fronts propagating along different axes having different adhesion strengths. For example, the pull force along the spooling axis of a tape can be made different from the pull force across the tape (i.e., perpendicular to the spooling axis). However, according to the principles of the invention, the adhesion strength can be made to depend not only on the axis of the pull, but also on the direction with respect to the sense of the pull, i.e., the orientation of the pull along the axis of pull. In other words, the adhesive strength of peeling a tape from left to right can be significantly different than that from peeling right to left. This methodology includes patterning an interface with a heterogeneous distribution of adhesion energy.

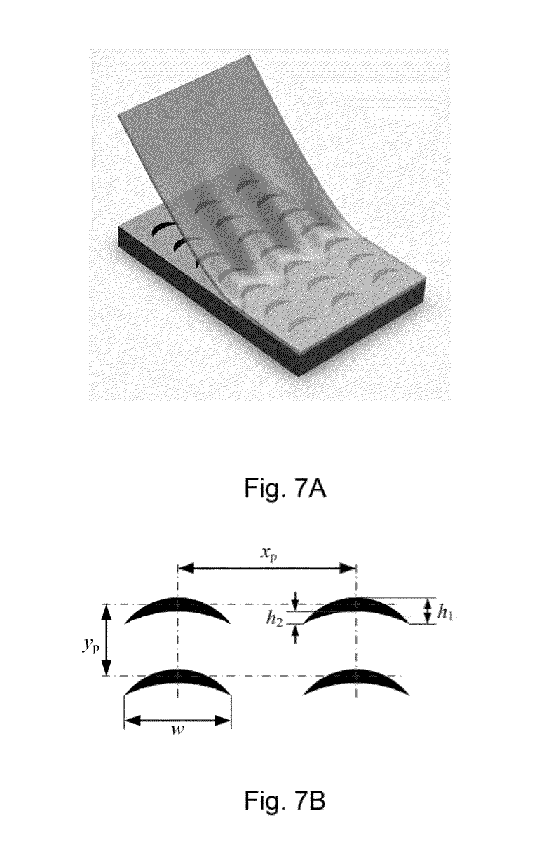

FIG. 7A shows a translucent polydimethylsiloxane (PDMS) film or tape being peeled from a substrate with a heterogeneous distribution of the adhesive energy. In one particular embodiment, the substrate is made of a thick transparency sheet attached to a glass plate and the heterogeneous distribution of the adhesive energy was achieved by printing ink patterns onto the transparency with a Lexmark laser printer. The adhesion energies of PDMS-transparency and PDMS-ink interfaces are measured by standard peel tests to be 0.65 and 3.55 J/m², respectively. The preparation procedure of the PDMS sheet is as follows. The elastomer and curing agent of PDMS (Sylgard 184, Dow Corning Co.) are mixed at a weight ratio of 10:1, and degassed in a vacuum chamber for 30 minutes to remove trapped air bubbles. The liquid PDMS premix is poured on the transparency, followed by curing at room temperature for 24 hours and then 80° C. for 1 hour.

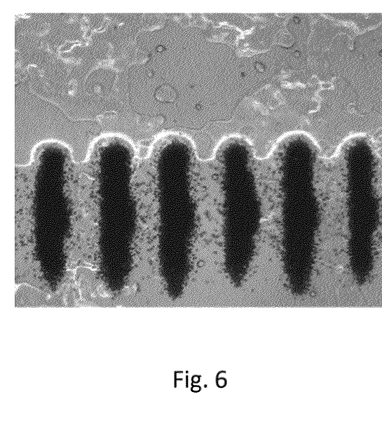

As the PDMS film is peeled, the peeling front becomes wavy as it tries to go ahead in the weaker region but is held back in the tougher region. FIG. 6 shows the top view of the peeling process and the wavy front where the printed pattern consists of an array of dark ovals. This wavy front results in corrugations of the tape transverse to the overall peeling direction. Introduced at the right length-scale, these corrugations increase the resistance of the tape to bend along the overall peeling direction. This creates nonlocal interactions so that the shape of the front is a collective response to the overall pattern instead of the local shape.

According to the principles of the invention, this effect can be exploited to create directionality. Specifically, a properly designed pattern that is asymmetric with respect to the propagation direction will generate a peel front whose shape is different depending on the sense or direction of pull along the pull axis. Depending on the embodiment, this directionality can be significant.

FIGS. 7A and 7B show the geometry of a moon or crescent-like ink pattern printed on the transparency. The pattern is bounded by two arcs or curvilinear elements, whose geometry is defined by arc heights, h₁ and h₂, and a common arc width, w. A periodic heterogeneous microstructure is created by replicating the pattern along the horizontal and vertical directions, at spatial periods of xₚ and yₚ.

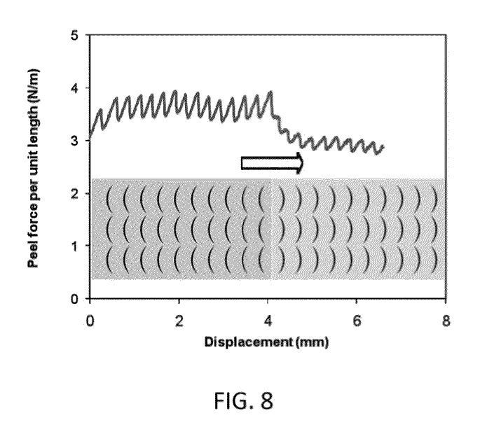

Reference is now made to FIG. 8, which shows adhesion directionality due to adhesive heterogeneity. The PDMS sheet is peeled at a peel angle of 45 degrees and a constant speed of 0.3 μm/s. The corresponding peel force is measured by a load cell with 200 g load capacity. The geometric parameters of the test specimen are: PDMS sheet width b=50.0 mm and thickness t=1.2 mm, pattern arc heights h₁=0.40 mm and h₂=0.27 mm, pattern width w=4.0 mm, pattern periods xₚ=10.0 mm and yₚ=1.0 mm. The system measured includes two regions with the pattern pointing in opposite directions. This allows an examination of the adhesive strength in both directions in a single test and removes artifacts of mounting and the like. As shown in the FIG. 8, the peeling force oscillates as it passes each column of arc-shaped regions of higher strength. More importantly, the effective adhesive strength in the forward region (front first touching the convex portion of the arc) is approximately 25% greater than that in the backward region. As the front propagates in the forward region, it first encounters the curved convex portion of the arc. The front sees them as significant obstacles, and therefore requires a large peeling front to overcome. On the other hand, as the front propagates in the backward region, it first encounters the narrow arms of the arc and sees these as smaller obstacles. According to the principles of the invention, parameters including geometry and adhesion energy distribution can be adjusted to achieve differing contrast in directional adhesion strength. Also according to the invention while the specific example shown in FIG. 7B includes a moon or crescent like shape more general shapes including general curvilinear shapes can be employed to achieve directionally different adhesion strength

According to one embodiment of the invention, the problem has been modeled analytically treating the film as a Föppl-von Kármán plate and also numerically using nonlinear shell theory. For now, it is noted that these models describe the phenomena well, and also provide a tool to optimize the pattern of the backing layer and/or the pattern of the adhesive layer for various objectives.

The potential applications of the present invention are broad as adhesive fronts can be considered a prototypical problem in materials science. The model used in accordance with the present invention suggests that the propagation of the adhesive front is described by an equation effectively of the form

{circumflex over (\dot{f}(k)=(−1)^{α+1}|k|^{α}\hat{f}(k)+\hat{N}(x,f)(k)

where y=f(x) describes the front, N(x,y) describes the adhesive pattern, α>0, the superimposed that denotes the Fourier transform and the superimposed dot denotes a time derivative. Numerous extended defects in solids that determine the properties of solids are described by equations of a similar form. These defects include but are not limited to dislocations, phase boundaries, and fracture fronts. Additional description regarding this can be found in the following references, all of which are hereby incorporated by reference in their entirety: R. Phillips, Crystals, defects and microstructures: Modeling across scales, Cambridge University Press, 2001.; J. P. Hirth and J. Lothe, Theory of dislocations, Krieger Publishing Company. 1992.; T. Mura, Micromechanics of defects in solids, Springer, 1987.; and V. Bulatov and W. Cai, Computer simulations of dislocations, Oxford University Press, 2006.

Other phenomena like wetting fronts and charge density waves are also described by similar equations. Much of the prior art literature on the subject focuses either on a single microstructural feature (i.e. where N is uniform except for a single bump) or on random microstructure (i.e., where N represents some quenched noise). By contrast, the present invention indicates that treating N as a complex but deterministic pattern is a useful form of analysis. According to the invention, this analysis provides an accurate description of the peeling process and the ability to design adhesive systems whose adhesion strength is increased and/or directional based on patterning of the backing and/or adhesive layer.

It is important to note that the patterns shown in the various drawings are illustrative only and other patterns with differing geometries are fully contemplated as within the scope of the present invention. The invention contemplates a film as part of an adhesive system that has at least two regions, each of which has different values of a physical property. In one embodiment the physical property is an elastic property such as bending stiffness and in another embodiment, the physical property is an adhesive property such as adhesive energy. In various embodiments, the regions form a pattern with at least one of the regions including a plurality of elements.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. An adhesive system that can be applied to a substrate, comprising:
a first region of a heterogeneous film having a first value of an elastic property; and
a second region of said heterogeneous film having a second value of said elastic property;
wherein said first region and said second region are configured to cooperate to enhance an adhesive strength of said adhesive system when said adhesive system is in contact with the substrate.

2. The system according to claim 1 wherein said elastic property is at least one of a thickness, an elastic modulus, and a Poisson's ratio.

3. The system according to claim 1, wherein said elastic property includes a bending stiffness.

4. The system, according to claim 3, wherein said first value and said second value of said bending stiffness are achieved by heterogeneity in at least one of a thickness and an elastic modulus.

5. The system according to claim 4, wherein heterogeneity in said thickness is achieved by at least one of mold pressing and patterned laminated structures.

6. The system according to claim 4, wherein heterogeneity in said elastic modulus is achieved by masked irradiation of said heterogeneous film, said heterogeneous film being made of an irradiation-sensitive material.

7. The system according to claim 1 further comprising an adhesive layer, said adhesive layer being disposed between said heterogeneous film and the substrate when said adhesive system is in contact with the substrate.

8. The system according to claim 1, wherein said first region and said second region form a pattern, at least one of said first region and said second region comprising a plurality of elements.

9. The system according to claim 8, wherein said pattern comprises at least one of a striped pattern and an array of squares.

10. A method of fabricating an adhesive system that can be applied to a substrate, comprising:
generating a first region of a heterogeneous film having a first value of an elastic property; and
generating a second region of said heterogeneous film having a second value of said elastic property;
wherein said first region and said second region are configured to cooperate to enhance an adhesive strength of said adhesive system when said adhesive system is in contact with the substrate.

11. The method according to claim 10, wherein said elastic property includes a bending stiffness.

12. The method according to claim 10, wherein said elastic property is spatially heterogeneous in a pattern.

13. The method according to claim 12, wherein said elastic property that is spatially heterogeneous in a pattern comprises at least one of:
a first array of striped regions having a first value of said elastic property interspersed with a second array of striped regions having a second value of said elastic property, and a first array of square regions having a first value of said elastic property, each of said square regions of said array surrounded by a second region having a second value of said elastic property.

14. An adhesive system that can be applied to a substrate, comprising:
a first region of a heterogeneous film having a first value of an elastic property; and
a second region of said heterogeneous film having a second value of said elastic property;
wherein said first region and said second region are configured to cooperate to provide directional anisotropy in removing said adhesive system from the substrate.

15. The system according to claim 14 wherein configured to cooperate to provide directional anisotropy in removing said adhesive system from the substrate includes exhibiting a first peel force value along a first direction and exhibiting a second peel force value along a second direction, said first peel force value being different from said second peel force value and said second direction being opposite to said first direction.

16. The system according to claim 14 wherein said first region and said second region are configured to cooperate to enhance an adhesive strength of said adhesive system when said adhesive system is in contact with the substrate.

17. The system according to claim 14 further comprising an adhesive layer, said adhesive layer being disposed between said heterogeneous film and the substrate when said adhesive system is in contact with the substrate.

18. An adhesive system that can be applied to a substrate, comprising:
a first region of a heterogeneous film having a first value of an adhesive property; and
a second region of said heterogeneous film having a second value of said adhesive property;
wherein said first region and said second region are configured to cooperate to provide directional anisotropy in removing said adhesive system from the substrate.

19. The system according to claim 18 wherein configured to cooperate to provide directional anisotropy in removing said adhesive system from the substrate includes exhibiting a first peel force value along a first direction and exhibiting a second peel force value along a second direction, said first peel force value being different from said second peel force value and said second direction being opposite to said first direction.

20. The system according to claim 18 wherein said first region comprises a plurality of curvilinear elements having a convex profile along a first direction and a concave profile along a second direction.

21. The system according to claim 20 further comprising an adhesive layer, said adhesive layer being disposed between said heterogeneous film and the substrate when said adhesive system is in contact with the substrate.
